(19) United States
(12) Patent Application Publication
(10) Pub. No.: US 2025/0214293 A1
(43) Pub. Date: Jul. 3, 2025

(54) LAMINATED RESIN TUBE AND MOLDING METHOD

(71) Applicant: SMC CORPORATION, Tokyo (JP)

(72) Inventor: Ikuo YOKOTA, Fuchu-shi (JP)

(73) Assignee: SMC CORPORATION, Tokyo (JP)

(21) Appl. No.: 18/983,704

(22) Filed: Dec. 17, 2024

(30) Foreign Application Priority Data
Dec. 27, 2023 (JP) 2023-222050

(51) Int. Cl. B29C 48/21; B29C 48/335; B29K 27/12; B29K 77/00; B29L 9/00; B29L 23/00

(52) U.S. Cl. CPC B29C 48/21; B29C 48/336; B29C 2791/003; B29K 2027/12; B29K 2077/00; B29K 2995/0026; B29K 2995/0072; B29K 2995/0097; B29L 2009/00; B29L 2023/22

(57) ABSTRACT

A laminated resin tube includes an inner layer containing a thermoplastic material which is a thermoplastic resin or a thermoplastic elastomer, an intermediate layer provided on the outer periphery of the inner layer and containing a polyamide, and an outer layer provided on the outer periphery of the intermediate layer and containing a fluoropolymer.

### CROSS-REFERENCE TO RELATED APPLICATIONS

This application is based upon and claims the benefit of priority from Japanese Patent Application No. 2023-222050 filed on Dec. 27, 2023, the contents of which are incorporated herein by reference.

### BACKGROUND OF THE INVENTION

### Field of the Invention

The present disclosure relates to a laminated resin tube and a molding method.

### Description of the Related Art

A laminated resin tube in which a plurality of layers are laminated is known. JP 2009-127631 A discloses a fuel tube which is formed by laminating an inner layer containing an ethylene tetrafluoroethylene copolymer resin (ETFE), and an outer layer made of a polyamide exhibiting good adhesiveness to the inner layer.

JP H06-234190 A discloses a hose for fuel piping of an automobile, which is formed by laminating an inner layer formed of a fluoropolymer, an intermediate layer formed of a synthetic resin other than the fluoropolymer, and an outer layer formed of a rubber elastic material. An adhesive layer made of a blend material of fluoropolymer and polyamide may be formed between the inner layer and the intermediate layer. Besides forming the adhesive layer, an adhesion treatment such as a flame treatment may be performed on the surface of the inner layer.

JP 2012-092901 A discloses a tube including an inner layer made of a thermoplastic resin, a reinforcing layer made of a metal braid and formed on the outer periphery of the inner layer, and an outer layer covering body formed of a fluoropolymer and covering the inner layer and the reinforcing layer. As the fluoropolymer that forms the outer layer covering body, an adhesive fluoropolymer can be used.

### SUMMARY OF THE INVENTION

There has been a demand for a laminated resin tube that is excellent in flexibility and bending performance (kink resistance) and can be easily produced.

The present disclosure has the object of solving the aforementioned problem.

According to a first aspect of the present disclosure, there is provided a laminated resin tube comprising: an inner layer containing a thermoplastic material which is a thermoplastic resin or a thermoplastic elastomer; an intermediate layer provided on an outer periphery of the inner layer and containing a polyamide; and an outer layer provided on an outer periphery of the intermediate layer and containing a fluoropolymer.

According to a second aspect of the present disclosure, there is provided a method for molding the laminated resin tube according to the first aspect, the method comprising: causing an inner layer extruder to heat and melt an inner layer material of the inner layer, the inner layer material containing the thermoplastic resin or the thermoplastic elastomer; causing an intermediate layer extruder to heat and melt an intermediate layer material of the intermediate layer, the intermediate layer material containing the polyamide; causing an outer layer extruder to heat and melt an outer layer material of the outer layer, the outer layer material containing the fluoropolymer; and simultaneously performing extrusion of the inner layer material from the inner layer extruder into a die by the inner layer extruder, extrusion of the intermediate layer material from the intermediate layer extruder into the die by the intermediate layer extruder, and extrusion of the outer layer material from the outer layer extruder into the die by the outer layer extruder, thereby performing co-extrusion molding of the inner layer, the intermediate layer, and the outer layer in the die.

According to the present disclosure, a laminated resin tube that is excellent in flexibility and bending performance and can be easily produced is obtained.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a view illustrating a configuration of a laminated resin tube according to an embodiment;

FIG. 2 is a schematic view for explaining a method for molding the laminated resin tube; and

FIG. 3 is a flowchart illustrating a processing procedure corresponding to the method for molding the laminated resin tube.

### DETAILED DESCRIPTION OF THE INVENTION

Heretofore, various resin tubes have been put into practical use. Seamless, uniform and long resin tubes can be mass-produced. Resin tubes are convenient for conveying gas or liquid. Resin tubes are used in large quantities in various industries. Resin tubes are used in, for example, food industries, medical treatments, transportation of fuels, paints, and the like, and piping parts for introducing high-pressure air.

Resin tubes are industrially important components. Therefore, many kinds of resin tubes which have been variously devised are put into practical use. For example, in a case where the resin tube must withstand high pressure, a resin tube made of a strong polyamide is selected. In a case where the resin tube transports an organic solvent, a resin tube made of a fluoropolymer having excellent chemical resistance is selected.

A laminated resin tube, which includes an inner layer and an outer layer and in which a reinforcing layer having a reinforcing yarn is provided between the inner layer and the outer layer, is also put into practical use. The inner layer is made of a material having a suitable quality according to the type of gas or liquid to be transported. The outer layer is made of a material that is not easily affected by the external environment and has high resistance to friction. The laminated resin tube includes the reinforcing layer and has therefore high pressure resistance.

It should be noted that the flexible tubular body used for transporting gas or liquid is sometimes referred to as a hose, in addition to a tube. In the following description, the tube is a concept including a hose. Further, the object transported by the resin tube is not limited to gas or liquid. Mixtures of gases and liquids can also be transported by the resin tube. Solids such as powders or granules can also be transported by the resin tube together with gas or liquid. Hereinafter, the object transported by the resin tube, such as gas, liquid, powders, and granules, is collectively referred to as a fluid.

A resin tube made of a fluoropolymer has high chemical resistance. In particular, a resin tube made of an ethylene tetrafluoroethylene copolymer resin (ETFE) can be processed at a relatively low temperature and is therefore widely used. However, many fluoropolymers including ETFE have low flexibility. Therefore, the flexibility of the resin tube made of a fluoropolymer is low. Accordingly, the resin tube made of a fluoropolymer is hard and lacks flexibility, and therefore, is difficult to bend and is not easy to use.

In addition, in general, the resin tube made of a fluoropolymer has poor bending performance. The bending performance of the resin tube is also referred to as kink resistance. In a case where an operator tries to bend the resin tube, the resin tube may be buckled and kinked without being bent. In this case, the tubular structure of the resin tube is narrowed, and a situation in which the fluid does not pass therethrough occurs. The kink resistance means that such a situation is less likely to occur. When the kink resistance is high, the operator can bend the resin tube largely without kinking it. That is, when kink resistance of the resin tube is high, the bending performance of the resin tube is high.

The resin tube having poor bending performance cannot be bent largely. That is, the bending radius of the resin tube having poor bending performance cannot be reduced. In the case of using a resin tube whose bending radius is severely restricted, the operator needs to handle the resin tube carefully.

It should be noted that the concept of flexibility and the concept of bending performance (kink resistance) are different from each other. For example, a tube that is hard and not easily bendable due to its poor flexibility may have excellent bending performance. When the operator carefully bends the tube with a strong force, the tube can be bent with a small bending radius without kinking.

As described above, the single-layer resin tube made of ETFE has a problem of low flexibility and poor bending performance. In order to solve such a problem, improvements have been made by the technique disclosed in JP 2009-127631 A and the technique disclosed in JP H06-234190 A. Specifically, by thinning the inner layer formed of ETFE which lacks flexibility, the bending resistance is alleviated. Further, the strength and the like are improved by the outer layer made of another resin material. These can improve the low flexibility and poor bending performance to a certain extent.

However, the surface energy of the fluoropolymer including ETFE is low. Therefore, the fluoropolymer has low adhesiveness to another resin. The friction between the layer made of the fluoropolymer and the layer made of another resin is also extremely low. That is, the fluoropolymer layer is easily peeled off from the other layer. If the peeling occurs, there is no substantial difference between the inner layer formed of the fluoropolymer and a single-layer fluoropolymer tube. Therefore, in the laminated resin tube formed by simply laminating another resin layer on the fluoropolymer layer, there is still a possibility that kinking occurs.

JP 2009-127631 A and JP H06-234190 A disclose techniques for reducing the above-described peeling between the fluoropolymer layer and the other layer. For example, it is disclosed that an intermediate layer made of a resin capable of ensuring a certain level of adhesiveness to the fluoropolymer is provided. It is also disclosed that the adhesiveness can be improved by modifying (for example, by performing chemical etching on) the resin material constituting the fluoropolymer layer.

However, the use of such a special material or surface treatment may cause problems such as an increase in the manufacturing cost of the laminated resin tube and a decrease in the long-term stability of the laminated resin tube. Further, even if the adhesiveness is improved, there is still a possibility that kinking occurs in the inner layer tube made of the fluoropolymer. In this case, the restrictions on the bending radius of the laminated resin tube are still severe.

In general, the fluoropolymer is inferior in transparency, and therefore, there is a possibility that the operator cannot visually recognize the inside of the laminated resin tube in a satisfactory manner. The reason for this will be described below. In a case where the laminated resin tube includes an inner layer made of a fluoropolymer, then, unless the adhesiveness between the fluoropolymer and the resin constituting an outer layer is extremely high, the possibility of occurrence of interlayer peeling is high as described above. Therefore, the bending performance of the laminated resin tube is low. In order to increase the above-described adhesiveness, various methods such as chemical etching of the adhesive surface of the inner layer or use of an adhesive resin having a large number of functional groups with high amine values can be applied.

However, even if any of the methods is applied, the transparency of the adhesive surface of the inner layer is impaired. Therefore, the visibility of the inside of the laminated resin tube is impaired. That is, the operator cannot visually recognize the inside of the laminated resin tube in a satisfactory manner. Whether or not the operator can visually check the presence or absence of the fluid inside the laminated resin tube has a great influence on the usability of the laminated resin tube, and therefore, the transparency described above is a great concern for the operator.

According to the technique disclosed in JP 2012-092901 A, the bending performance, the pressure resistance performance, and the slipperiness are secured in each of the inner layer, the reinforcing layer, and the outer layer covering body of the tube. The term “slipperiness” means that the friction of the outer surface of the tube is low. In the case of a tube having low slipperiness, the tube is not caught by another tube or the like, and thus the tube can be easily handled. Since the outer layer covering body, which is the outermost layer of the tube, is formed of a fluoropolymer, the tube has excellent slipperiness and chemical resistance on the outer surface of the tube.

However, in order to increase the pressure resistance and kink resistance of the tube, the tube is provided with the reinforcing layer made of a braid formed of metal wires. Therefore, the weight of the tube is heavy. In addition, since the metal wires are exposed on the cross section of the tube when the tube is cut, the operator needs to pay sufficient attention when using the tube, and the applications of the tube may be limited.

Further, it is disclosed that an adhesive fluoropolymer is selected as the fluoropolymer in order to ensure satisfactory adhesion between the fluoropolymer constituting the outer layer covering body, and the reinforcing layer or the like. It is also disclosed that, instead of selecting an adhesive fluoropolymer as the fluoropolymer, a defluorination treatment is performed on the fluoropolymer by chemical etching or the like. Therefore, the laminated resin tube cannot be produced easily, and improvement is desired from the viewpoint of the raw material cost, processing cost, and productivity.

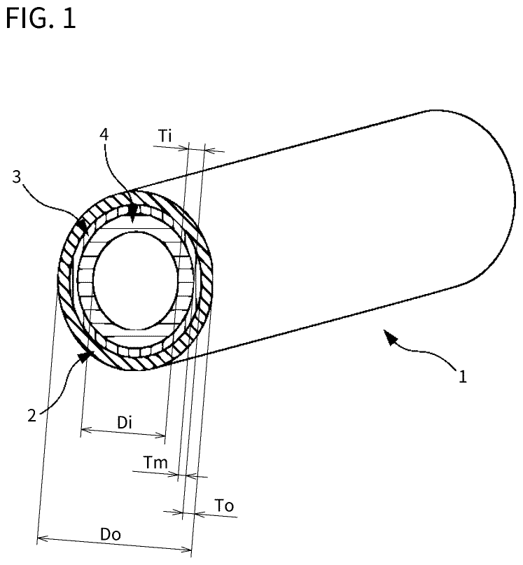

A laminated resin tube according to an embodiment will be described with reference to the drawings. FIG. 1 is a view illustrating a configuration of a laminated resin tube 1 according to the present embodiment. The laminated resin tube 1 has a tubular structure in which an inner layer 4, an intermediate layer 3, and an outer layer 2 are laminated in order from the inside and integrated together. The central portion of the laminated resin tube 1 is a hollow portion formed inside the inner layer 4. The central portion of the laminated resin tube 1 is used as a flow path for conveying a fluid.

The inner layer 4 of the laminated resin tube 1 is a circular tubular layer located on the innermost side of the laminated resin tube 1. Therefore, the inner layer 4 is in contact with the fluid transported in the laminated resin tube 1. The inner layer 4 contains a thermoplastic material having thermoplasticity. The thermoplastic material used for the inner layer 4 is a thermoplastic resin or a thermoplastic elastomer. The thermoplastic resin and the thermoplastic elastomer have high elasticity and high flexibility. A specific material used as the thermoplastic resin or the thermoplastic elastomer can be selected as appropriate according to the intended use or the required function of the laminated resin tube 1.

In a case where a thermoplastic resin is used as the thermoplastic material used for the inner layer 4, the thermoplastic resin is, for example, a polyurethane resin or a polyvinyl chloride resin. In a case where a thermoplastic elastomer is used as the thermoplastic material used for the inner layer 4, the thermoplastic elastomer is, for example, a polyurethane-based elastomer, a polyamide-based elastomer, an olefin-based elastomer, or a polystyrene-based elastomer.

That is, the inner layer 4 contains, for example, any of a polyurethane resin, a polyvinyl chloride resin, a polyurethane-based elastomer, a polyamide-based elastomer, an olefin-based elastomer, or a polystyrene-based elastomer.

The above-mentioned thermoplastic resin and thermoplastic elastomer used for the inner layer 4 have appropriate strength and elasticity according to the intended use of the laminated resin tube 1. In this manner, the laminated resin tube 1 that is excellent in flexibility and bending performance (kink resistance) is obtained. Therefore, the laminated resin tube 1 is easy to use.

It should be noted that, in a case where the above-described thermoplastic material is used for the inner layer 4, resin materials of various grades having both strength and elasticity can be selected according to the intended use of the laminated resin tube 1. In a case where a polyurethane resin or a polyurethane-based elastomer is used for the inner layer 4, a material of a grade having particularly excellent flexibility and elasticity can be selected. In this case, the laminated resin tube 1 which is more flexible and has excellent bending performance as a whole is obtained.

Some polyurethane-based elastomers can be produced at a relatively low cost while having particularly excellent flexibility and sufficient strength. Therefore, the laminated resin tube 1 in which the polyurethane-based elastomer is used for the inner layer 4 has remarkable flexibility and bending performance, and can be provided at low cost.

It is preferable that the thermoplastic material used for the inner layer 4 does not contain a fluoropolymer. This allows the inner layer 4 to maintain its flexibility. Therefore, it is possible to avoid obtaining the laminated resin tube 1 which is not easy to use, such as having severe restrictions on the bending radius and being inferior in flexibility.

In addition, in a case where the inner layer 4 is a fluoropolymer layer, the layers can be easily peeled off by bending of the laminated resin tube 1, and therefore, the bending performance of the inner layer 4 is poor. In a case where the bending performance of the inner layer 4 is poor, the inner layer 4 easily buckles (kinks), and the above-described tubular structure may be narrowed. In this case, an accident in which gas or liquid does not flow in the laminated resin tube 1 is likely to occur. In a case where the thermoplastic material used for the inner layer 4 does not contain a fluoropolymer, such an accident can be prevented.

The intermediate layer 3 of the laminated resin tube 1 is provided on the outer periphery of the inner layer 4. The intermediate layer 3 contains a polyamide. The outer layer 2 of the laminated resin tube 1 is provided on the outer periphery of the intermediate layer 3. The outer layer 2 contains a fluoropolymer having low adhesiveness as described later. However, the intermediate layer 3 contains the polyamide, and therefore, adheres to the inner layer 4 and the outer layer 2 in a satisfactory manner.

Specifically, by providing the polyamide layer, which is the intermediate layer 3, between the inner layer 4 and the outer layer 2, the adhesiveness between the thermoplastic resin or thermoplastic elastomer contained in the inner layer 4 and the fluoropolymer contained in the outer layer 2 is improved. Since the respective layers of the laminated resin tube 1 are integrally fixed without peeling, a failure such as the intrusion of the conveyed fluid between the layers can be prevented.

The fluoropolymer contained in the outer layer 2 generally has high chemical resistance and excellent slipperiness. Therefore, the outer layer 2 has excellent chemical resistance and good slipperiness in the external environment in which the laminated resin tube 1 is used. Dirt or the like hardly adheres to the the outer layer 2.

Various types of fluoropolymers can be used for the outer layer 2. The fluoropolymer used for the outer layer 2 is, for example, an ethylene tetrafluoroethylene copolymer resin (ETFE) or a tetrafluoroethylene-perfluoroalkyl vinyl ether-chlorotrifluoroethylene copolymer resin. That is, the outer layer 2 contains, for example, any one of a polyurethane resin, a polyvinyl chloride resin, a polyurethane-based elastomer, a polyamide-based elastomer, an olefin-based elastomer, or a polystyrene-based elastomer.

The fluoropolymer used for the outer layer 2 is preferably ETFE. Among fluoropolymers, ETFE has relatively excellent mechanical properties, relatively easy moldability, and sufficiently high chemical resistance. With respect to chemical resistance, ETFE has sufficient performance against many kinds of solvents, acids, alkalis, and other fluids. ETFE has high chemical resistance compared with the thermoplastic resin or thermoplastic elastomer used for the inner layer 4.

The laminated resin tube 1 is a circular tubular structure. Therefore, a strong tensile stress may be generated in the outermost peripheral portion of the laminated resin tube 1 due to bending or twisting of the laminated resin tube 1. In addition, various fluids can be conveyed in the laminated resin tube 1 for a long period of time. Even in such a case, the outer layer 2 in which ETFE is used is less likely to deteriorate. Therefore, the possibility of occurrence of an accident in which the laminated resin tube 1 is broken due to deterioration of the outer layer 2 during use of the laminated resin tube 1 is suppressed.

As described above, the tetrafluoroethylene-perfluoroalkyl vinyl ether-chlorotrifluoroethylene copolymer resin may be used for the outer layer 2. The tetrafluoroethylene-perfluoroalkyl vinyl ether-chlorotrifluoroethylene copolymer resin also has sufficient performance similar to that of ETFE.

The laminated resin tube 1 is used for the purpose of transporting a fluid. Usually, the type and state of the fluid with which the inner layer 4 is in contact are controlled in advance. The outer layer 2 exposed to the external environment may be subjected to stresses such as high heat in an accident or a momentary electric spark. The outer layer 2 has high heat resistance and high flame retardancy peculiar to the fluoropolymer.

The melting point of the fluoropolymer is relatively high. Fluoropolymers meet the flame retardant grade V-0 of UL94 “The Standard for Tests for Flammability of Plastic Materials for Parts in Devices and Appliances” defined by UL Solutions, a certification authority in the United States. Therefore, the outer layer 2 can maintain high heat resistance and high flame retardancy even when subjected to the above-described stresses.

In a conventional laminated resin tube, a hard fluoropolymer which is inferior in elasticity is used for an inner layer, and a flexible thermoplastic resin or thermoplastic elastomer which is superior in elasticity is used for an outer layer. Such a conventional laminated resin tube can be likened to a state in which a soft rubber is wound around a hard pipe. The inner hard pipe can be kinked when bent, although the rubber is wound therearound. That is, in a case where the conventional laminated resin tube is bent, kinking is likely to occur.

The laminated resin tube 1 according to the present embodiment can be likened to a state in which a soft rubber tube serving as the inner layer 4 is wrapped in a hard sheath serving as the outer layer 2. The inner soft rubber tube is not easily kinked when bent. That is, in a case where the laminated resin tube 1 according to the present embodiment is bent, kinking is unlikely to occur.

Therefore, in the laminated resin tube 1 according to the present embodiment, peeling between the inner layer 4 and the outer layer 2 is less likely to occur than in the conventional laminated resin tube. In the laminated resin tube 1, as described above, the polyamide layer serving as the intermediate layer 3 is further provided between the inner layer 4 and the outer layer 2. The intermediate layer 3 contains a polyamide, and therefore, the adhesiveness between the inner layer 4 and the outer layer 2 is enhanced. That is, the adhesiveness between the respective layers of the laminated resin tube 1 is enhanced.

Therefore, the possibility of occurrence of interlayer peeling is low during normal use of the laminated resin tube 1. It is possible to prevent a failure such as the intrusion of the conveyed fluid between the layers due to the interlayer peeling.

In the present embodiment, a thickness Ti of the inner layer 4 is the largest among the inner layer 4, the intermediate layer 3, and the outer layer 2. Specifically, a thickness Tm of the intermediate layer 3 and a thickness To of the outer layer 2 are both smaller than the thickness Ti of the inner layer 4. In a case where the outer layer 2 is sufficiently thin, the outer layer 2 is easily bent flexibly. This can suppress the influence of the fluoropolymer contained in the outer layer 2 on the flexibility and bending performance of the entire laminated resin tube 1. The thickness To of the outer layer 2 is preferably ⅓ or less of the sum of the thickness Ti of the inner layer 4, the thickness Tm of the intermediate layer 3, and the thickness To of the outer layer 2, for example. In this case, the laminated resin tube 1, which has high flexibility and excellent bending performance, and is more convenient to use, is obtained.

It is possible to manufacture the laminated resin tube 1 with various inner diameters and outer diameters. In general, a consumer selects and uses the laminated resin tube 1 having a suitable size according to the purpose. For example, the laminated resin tube 1 shown in FIG. 1 has an inner diameter Di of 6 mm, and an outer diameter Do of 8 mm. Specifically, the inner diameter of the inner layer 4 of the laminated resin tube 1 is 6 mm, and a thickness (wall thickness) T of the tube wall of the laminated resin tube 1 is 1 mm.

The thickness T of the tube wall of the laminated resin tube 1 is the sum of the thickness Ti of the inner layer 4, the thickness Tm of the intermediate layer 3, and the thickness To of the outer layer 2. In the example shown in FIG. 1, the thickness Ti of the inner layer 4 is 0.7 mm, the thickness Tm of the intermediate layer 3 is 0.1 mm, and the thickness To of the outer layer 2 is 0.2 mm. Therefore, the value of 0.2 mm, which is the thickness To of the outer layer 2, is no more than ⅓ of 1 mm, which is the sum of the thickness Ti of the inner layer 4, the thickness Tm of the intermediate layer 3, and the thickness To of the outer layer 2.

When the thickness Tm of the intermediate layer 3 increases, the laminated resin tube 1 becomes hard, and therefore, the laminated resin tube 1 becomes difficult to bend. Further, since the amount of moisture absorption increases, a dimensional change of the laminated resin tube 1 occurs. That is, the performance of the entire laminated resin tube 1 is deteriorated. Further, since the polyamide contained in the intermediate layer 3 is relatively expensive, the manufacturing cost of the intermediate layer 3 increases.

Therefore, it is preferable to make the thickness Tm of the intermediate layer 3 sufficiently thin. For example, when the thickness Tm of the intermediate layer 3 is 0.2 mm or less, practical problems of the laminated resin tube 1 can be suppressed. As described above, in the present embodiment, the thickness Tm of the intermediate layer 3 is 0.1 mm, which is no more than 0.2 mm. This maintains the flexibility of the laminated resin tube 1 and suppresses the dimensional change of the laminated resin tube 1 due to moisture absorption. Further, since the amount of the polyamide is small, the raw material cost can be suppressed.

A ratio rd of the outer diameter Do to the inner diameter Di of the laminated resin tube 1 is an important parameter in designing the laminated resin tube 1. The ratio rd of the outer diameter Do to the inner diameter Di of the laminated resin tube 1 is expressed by the formula “rd=Do/Di”.

The thickness T of the tube wall of the laminated resin tube 1 is obtained by multiplying the difference between the outer diameter Do and the inner diameter Di of the laminated resin tube 1 by ½. When the ratio rd of the outer diameter Do to the inner diameter Di of the laminated resin tube 1 increases, the thickness T of the tube wall of the laminated resin tube 1 also increases. Therefore, the laminated resin tube 1 is strong and excellent in shape stability. That is, the bending performance of the laminated resin tube 1 is excellent. However, the laminated resin tube 1 becomes hard and is not easily flexed. That is, the flexibility of the laminated resin tube 1 is poor.

As the ratio rd of the outer diameter Do to the inner diameter Di of the laminated resin tube 1 decreases and approaches 1, the thickness T of the tube wall of the laminated resin tube 1 decreases. Therefore, the laminated resin tube 1 becomes soft and is easily flexed. That is, the laminated resin tube 1 has excellent flexibility. However, the laminated resin tube 1 is easily kinked and has poor shape stability. That is, the bending performance of the laminated resin tube 1 is poor. In addition, the strength of the laminated resin tube 1 may also be reduced.

Therefore, the ratio rd of the outer diameter Do to the inner diameter Di of the laminated resin tube 1 is preferably a value within a predetermined range K in which the flexibility and the bending performance of the laminated resin tube 1 are appropriate. The predetermined range K is, for example, a range from 1.3 to 1.6. That is, the ratio rd is preferably a value within the predetermined range K of 1.3 or more and 1.6 or less. In the present embodiment, the ratio rd of the outer diameter Do to the inner diameter Di of the laminated resin tube 1 is 8/6≈1.33, which is a value within the predetermined range K of 1.3 or more and 1.6 or less. Consequently, the laminated resin tube 1 can have appropriate flexibility and bending performance.

As described above, the inner layer 4 has appropriate strength and elasticity. The inner layer 4 greatly contributes to the laminated resin tube 1 exhibiting satisfactory flexibility and bending performance. A ratio ri of the inner diameter of the inner layer 4 to the thickness T of the tube wall of the laminated resin tube 1 is preferably a value within a predetermined range L. The inner diameter of the inner layer 4 is equal to the inner diameter Di of the laminated resin tube 1.

The thickness T of the tube wall of the laminated resin tube 1 is equal to the sum of the thickness Ti of the inner layer 4, the thickness Tm of the intermediate layer 3, and the thickness To of the outer layer 2. Therefore, the ratio ri is expressed by the formula “ri=Di/(Ti+Tm+To)”. The predetermined range L is, for example, a range of 3.33 or more and 6.0 or less. That is, the ratio ri is preferably a value within the predetermined range L of 3.33 or more and 6.0 or less. Consequently, the laminated resin tube 1 can exhibit satisfactory flexibility and bending performance.

In the present embodiment, the ratio ri of the inner diameter of the inner layer 4 equal to the inner diameter Di of the laminated resin tube 1, to the thickness T of the tube wall of the laminated resin tube 1 equal to the sum of the thickness Tm of the intermediate layer 3 and the thickness To of the outer layer 2 is 6/(0.7+0.1+0.2)=6, which is a value within the predetermined range L of 3.33 or more and 6.0 or less.

As described above, the outer layer 2 contains a fluoropolymer. Many fluoropolymers including ETFE have low transparency. As the thickness of the outer layer 2 increases, the transparency of the laminated resin tube 1 decreases. When the transparency of the laminated resin tube 1 decreases, it becomes difficult to visually check the fluid transported in the laminated resin tube 1. In this case, the usability of the laminated resin tube 1 is deteriorated. In order to ensure transparency of the laminated resin tube 1, the thickness To of the outer layer 2 is preferably ½ or less of the sum of the thickness Ti of the inner layer 4 and the thickness Tm of the intermediate layer 3, and 0.5 mm or less.

This allows the outer layer 2 to be relatively thin. Since the transparency of the laminated resin tube 1 is ensured, the fluid transported in the laminated resin tube 1 can be visually recognized in a satisfactory manner. Therefore, the laminated resin tube 1 is easy to use. Even if the outer layer 2 is relatively thin, the chemical resistance, heat resistance, and flame retardancy of the fluoropolymer contained in the outer layer 2 is obtained.

In the present embodiment, the thickness To of the outer layer 2 is 0.2 mm, which is no more than 0.5 mm. One-half of the sum of 0.7 mm, which is the thickness Ti of the inner layer 4, and 0.1 mm, which is the thickness Tm of the intermediate layer 3, is 0.4 mm. Therefore, the thickness To of the outer layer 2 is ½ or less of the sum of the thickness Ti of the inner layer 4 and the thickness Tm of the intermediate layer 3.

As described above, the inner layer 4 contains a thermoplastic resin or a thermoplastic elastomer. The thermoplastic resin or thermoplastic elastomer is transparent, but can be easily colored in various colors. Incidentally, it is convenient and practical and is therefore sometimes required that the fluid transported in the laminated resin tube 1 can be visually recognized from the outside of the laminated resin tube 1 in a satisfactory manner. In this case, the inner layer 4 is preferably transparent even when colored. That is, the inner layer 4 is colorless and transparent, or colored and transparent.

The color of the inner layer 4, including the colorless color, can be visually recognized as the color of the entire laminated resin tube 1. By using a plurality of laminated resin tubes 1 including colorless laminated resin tubes 1 and laminated resin tubes 1 of various colors, it becomes easy to visually distinguish the plurality of laminated resin tubes 1.

In various applications such as industrial applications and medical applications, a large number of the laminated resin tubes 1 may be used at the same time. For example, a plurality of laminated resin tubes 1 can convey different kinds of fluids in one device or the like. In this case, the plurality of laminated resin tubes 1 can be visually distinguished based on the color of each laminated resin tube 1. Therefore, it is possible to detect or prevent the wrong connection of one or more laminated resin tubes 1.

By coloring the entire inner layer 4, the plurality of laminated resin tubes 1 can be visually distinguished even when partially bundled. For example, the plurality of laminated resin tubes 1 can be distinguished based on the color of the portion of each laminated resin tube 1 that is not bundled. In addition, the colored inner layer 4 is covered with the intermediate layer 3 and the outer layer 2. Therefore, the color is not lost by abrasion of the outer surface of the laminated resin tube 1. Further, the color is not lost also when the dirt adhering to the outer surface of the laminated resin tube 1 is removed.

As described above, the thermoplastic resin or thermoplastic elastomer used for the inner layer 4 is transparent. It is preferable to select a thermoplastic resin or a thermoplastic elastomer having high transparency. Further, it is more preferable that the surface of the inner layer 4 is not subjected to a surface treatment by chemical etching or defluorination treatment.

The fact that the laminated resin tube 1 enables the fluid being transported in the laminated resin tube 1 to be visually confirmed from the outside of the laminated resin tube 1 can greatly contribute to the convenience of the laminated resin tube 1. However, for example, even when the transparency of the laminated resin tube 1 is in a state of being lowered like frosted glass, it is sufficient that the presence or absence of the fluid in the laminated resin tube 1 can be determined.

It is assumed that the ratio of the thickness Ti of the inner layer 4 to the thickness T of the tube wall of the laminated resin tube 1 (the sum of the thickness Ti of the inner layer 4, the thickness Tm of the intermediate layer 3, and the thickness To of the outer layer 2) is high. In this case, the transparency of the resin used for the inner layer 4 greatly affects the transparency of the entire laminated resin tube 1. In other words, the transparency of the resin used for the inner layer 4 is preferably high.

It is assumed that the surface of the inner layer 4 is chemically etched for the purpose of enhancing the adhesiveness between the layers of the laminated resin tube 1. In this case, the transparency of the inner layer 4 decreases, and as a result, the transparency of the entire laminated resin tube 1 also decreases. In the laminated resin tube 1 according to the present embodiment, the inner layer 4 in which a flexible thermoplastic resin or thermoplastic elastomer having excellent elasticity is used is wrapped in the outer layer 2 in which a hard fluoropolymer is used, in a sheath-like manner. Therefore, as described above, in the laminated resin tube 1 according to the present embodiment, peeling between the inner layer 4 and the outer layer 2 is less likely to occur than in the conventional laminated resin tube. Therefore, the necessity of performing a surface treatment such as chemical etching on the surface of the inner layer 4 is low.

Similarly to the inner layer 4, the intermediate layer 3 also preferably has high transparency. Further, it is preferable that also the surface of the intermediate layer 3 is not subjected to a surface treatment by chemical etching or defluorination treatment.

It should be noted that a usage form of the laminated resin tube 1 in which it is not necessary to visually recognize the fluid transported in the laminated resin tube 1 can be considered. If the usage form requires that the fluid not be exposed to light, the inner layer 4 may be colored opaque. In this case, the inner layer 4 is colored in, for example, opaque black. The thermoplastic resin or thermoplastic elastomer of the inner layer 4 can be easily colored in various opaque colors. This prevents the fluid conveyed in the laminated resin tube 1 from being exposed to light. Even if the surface of the outer layer 2 of the laminated resin tube 1 wears, the opaque color of the inner layer 4 is maintained, and therefore, the possibility of the light shielding property being lowered is low.

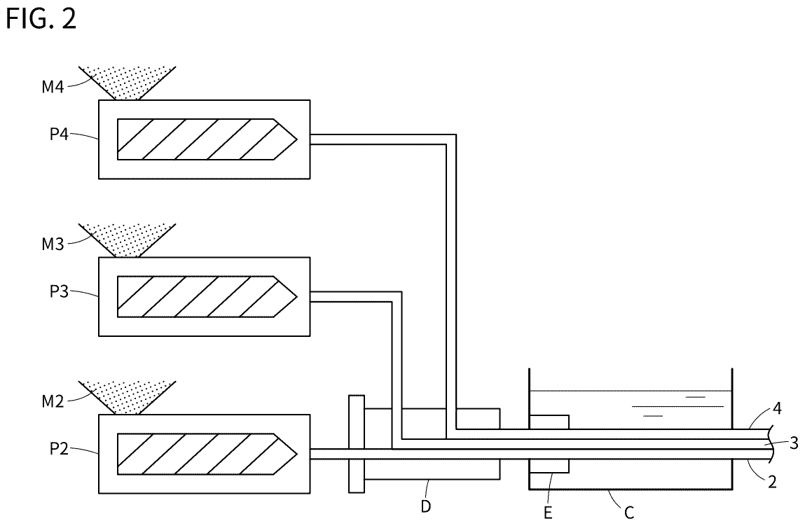

FIG. 2 is a schematic view for explaining a method for molding the laminated resin tube 1. An inner layer material M4 for the inner layer 4 contains the above-described thermoplastic resin or thermoplastic elastomer. An inner layer extruder P4 heats and melts the inner layer material M4 inside the inner layer extruder P4. An intermediate layer material M3 for the intermediate layer 3 contains the above-described polyamide. An intermediate layer extruder P3 heats and melts the intermediate layer material M3 inside the intermediate layer extruder P3. An outer layer material M2 for the outer layer 2 contains the above-described fluoropolymer. An outer layer extruder P2 heats and melts the outer layer material M2 inside the outer layer extruder P2.

The inner layer extruder P4 can extrude the inner layer material M4 from the inner layer extruder P4 into a die D. The intermediate layer extruder P3 can extrude the intermediate layer material M3 from the intermediate layer extruder P3 into the die D. The outer layer extruder P2 can extrude the outer layer material M2 from the outer layer extruder P2 into the die D.

The extrusion of the inner layer material M4 by the inner layer extruder P4, the extrusion of the intermediate layer material M3 by the intermediate layer extruder P3, and the extrusion of the outer layer material M2 by the outer layer extruder P2 are simultaneously performed. As a result, co-extrusion molding of the inner layer 4, the intermediate layer 3, and the outer layer 2 is performed in the die D. The resin materials in a melted state that constitute the inner layer 4, the intermediate layer 3, and the outer layer 2 are laminated inside the die D, whereby the laminated resin tube 1 is molded.

Subsequently, the inner layer 4, the intermediate layer 3, and the outer layer 2 are cooled by a cooling device C while being supported by a forming die E. In this way, the laminated resin tube 1 is continuously molded. Therefore, the laminated resin tube 1 which is seamless and extremely long is obtained. Further, since the productivity of the laminated resin tube 1 can be improved, mass production is possible. In other words, the manufacturing cost of the laminated resin tube 1 can be suppressed.

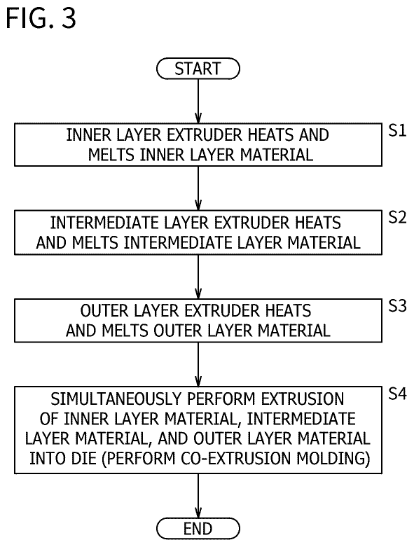

FIG. 3 is a flowchart illustrating a processing procedure corresponding to the method for molding the laminated resin tube 1. When this processing procedure is started, the inner layer extruder P4 heats and melts the inner layer material M4 in step S1. In step S2, the intermediate layer extruder P3 heats and melts the intermediate layer material M3. In step S3, the outer layer extruder P2 heats and melts the outer layer material M2.

In step S4, the inner layer extruder P4 extrudes the inner layer material M4 into the die D. The intermediate layer extruder P3 extrudes the intermediate layer material M3 into the die D. The outer layer extruder P2 extrudes the outer layer material M2 into the die D. The inner layer extruder P4, the intermediate layer extruder P3, and the outer layer extruder P2 simultaneously extrude their respective materials into the die D. That is, co-extrusion molding of the inner layer 4, the intermediate layer 3, and the outer layer 2 is performed. When the process of step S4 is completed, this processing procedure is ended.

As described above, the fluoropolymer used for the outer layer 2 is preferably ETFE. The melt viscosity of ETFE is relatively low. Therefore, among fluoropolymers, ETFE can be easily extrusion-molded at a relatively low temperature. Further, ETFE is relatively adhesive among fluoropolymers. Therefore, the outer layer 2 in which ETFE is used easily adheres to the intermediate layer 3 due to co-extrusion molding of the inner layer 4, the intermediate layer 3 and the outer layer 2.

As described above, the fluoropolymer used for the outer layer 2 may be a tetrafluoroethylene-perfluoroalkyl vinyl ether-chlorotrifluoroethylene copolymer resin. As the tetrafluoroethylene-perfluoroalkyl vinyl ether-chlorotrifluoroethylene copolymer resin, a material of a grade having more excellent moldability and/or adhesiveness than ETFE can be used. Consequently, the productivity of the laminated resin tube 1 can be further improved, and the possibility of occurrence of interlayer peeling can be further suppressed.

As described above, a resin material having thermoplasticity is used for the inner layer 4. As a resin material that can be used to manufacture the laminated resin tube 1 by co-extrusion molding, any of a polyurethane-based elastomer, a polyamide-based elastomer, an olefin-based elastomer, a polystyrene-based elastomer, or polyvinyl chloride resin is preferably selected.

For example, a polyurethane-based elastomer, a polyamide, and ETFE can be used as the inner layer material M4, the intermediate layer material M3, and the outer layer material M2, respectively. As the inner layer material M4, for example, a colorless transparent polyurethane-based elastomer which is not colored, a transparent polyurethane-based elastomer which is colored in blue, a slightly transparent polyurethane-based elastomer which is colored in white, an opaque polyurethane-based elastomer which is colored in black, or the like can be used.

The inner layer material M4, the intermediate layer material M3, and the outer layer material M2 are simultaneously supplied to the die D and the subsequent forming die E. In this manner, the inner layer 4, the intermediate layer 3, and the outer layer 2 are molded by co-extrusion, whereby the laminated resin tube 1 is manufactured. The inner layer material M4, the intermediate layer material M3, and the outer layer material M2 are extruded into the die D in a melted state by high temperature, and laminated. Therefore, the respective layers uniformly adhere to each other, and the occurrence of peeling between the layers is suppressed.

The forming die E controls the surface roughness and lubrication of the outer layer 2. The arithmetic average roughness of the surface of the outer layer 2 is preferably 0.1 μm or less. This suppresses strong haze like frosted glass that occurs on the surface of the fluoropolymer contained in the outer layer 2. As described above, by thinning the outer layer 2 containing a fluoropolymer having low transparency, the transparency of the laminated resin tube 1 is ensured. In addition, by setting the arithmetic average roughness of the surface of the outer layer 2 to 0.1 μm or less, the transparency of the laminated resin tube 1 can be improved.

That is, the surface of the laminated resin tube 1, on which the surface of the outer layer 2 using ETFE is exposed, becomes uniform and smooth. Therefore, the fluid transported in the laminated resin tube 1 can be visually recognized from the outside of the laminated resin tube 1 in a satisfactory manner.

More preferably, the arithmetic average roughness of the surface of the outer layer 2 is 0.1 μm or less, and the maximum height roughness of the surface of the outer layer 2 is 1 μm or less. In this case, since fine scratches are not observed on the surface of the laminated resin tube 1, the surface of the laminated resin tube 1 has a smooth and uniform appearance. This can prevent a decrease in marketability due to the appearance of the laminated resin tube 1.

In addition, when a scratch is generated on the surface of the laminated resin tube 1, the scratch is conspicuous because there is no fine scratch around that scratch. Therefore, it is easy to visually recognize and/or distinguish a scratch generated on the surface of the laminated resin tube 1 when using the laminated resin tube 1. Thus, it is possible to appropriately determine whether to perform replacement or the like of the laminated resin tube 1 for the purpose of maintaining the performance thereof.

The above-described embodiment may be modified as follows. In the following modifications, description overlapping with that of the embodiment will be omitted.

### Modification

In the above-described embodiment, the intermediate layer 3 of the laminated resin tube 1 is provided on the outer periphery of the inner layer 4. However, a reinforcing layer including a reinforcing yarn made of resin may be provided between the inner layer 4 and the intermediate layer 3. The reinforcing yarn of the reinforcing layer is wound around the inner layer 4. By providing such a reinforcing layer, the laminated resin tube 1 can have high pressure resistance performance.

The following supplementary notes are further disclosed in relation to the above-described embodiment and modification.

### Supplementary Note 1

The laminated resin tube (1) of the present disclosure includes the inner layer (4) containing a thermoplastic material which is a thermoplastic resin or a thermoplastic elastomer, the intermediate layer (3) provided on the outer periphery of the inner layer and containing a polyamide, and the outer layer (2) provided on the outer periphery of the intermediate layer and containing a fluoropolymer. Since the inner layer contains a thermoplastic material, a laminated resin tube having high flexibility and high bending performance is obtained. Since the intermediate layer is provided on the outer periphery of the inner layer, the adhesiveness of the outer layer containing a fluoropolymer is improved, and the occurrence of a failure such as interlayer peeling is suppressed. The outer layer contains a fluoropolymer, and therefore has excellent chemical resistance and excellent flame retardancy. Therefore, a laminated resin tube that is easy to use is obtained. Further, since the interlayer peeling is less likely to occur, it is not necessary to enhance the adhesiveness by performing chemical etching or defluorination treatment on the outer surface of the inner layer or the outer surface of the intermediate layer. Therefore, the transparency of the laminated resin tube is easily ensured.

### Supplementary Note 2

In the laminated resin tube according to Supplementary Note 1, the thickness (To) of the outer layer may be equal to or less than one-third of the sum of the thickness (Ti) of the inner layer, the thickness (Tm) of the intermediate layer, and the thickness of the outer layer. According to such a configuration, a laminated resin tube having higher flexibility and higher bending performance is obtained.

### Supplementary Note 3

In the laminated resin tube according to Supplementary Note 1, the fluoropolymer may be an ethylene tetrafluoroethylene copolymer resin (ETFE) or a tetrafluoroethylene-perfluoroalkyl vinyl ether-chlorotrifluoroethylene copolymer resin. In a case where the fluoropolymer used for the outer layer is ETFE, the outer layer can be molded by extrusion. By performing co-extrusion molding of the inner layer, the intermediate layer, and the outer layer, a seamless and extremely long laminated resin tube is obtained. Further, the outer layer in which ETFE is used adheres to the intermediate layer in a satisfactory manner. Therefore, a failure such as interlayer peeling is suppressed. Further, even when the inner layer is deteriorated due to long-term use or the like of the laminated resin tube, deterioration of the outer layer can be suppressed. That is, deterioration of the laminated resin tube as a whole is suppressed. In a case where the fluoropolymer used for the outer layer is a tetrafluoroethylene-perfluoroalkyl vinyl ether-chlorotrifluoroethylene copolymer resin, a failure such as interlayer peeling is further suppressed. In addition, the productivity of the laminated resin tube can be further improved.

### Supplementary Note 4

In the laminated resin tube according to Supplementary Note 1, the thermoplastic material may be any one of a polyurethane resin, a polyvinyl chloride resin, a polyurethane-based elastomer, a polyamide-based elastomer, an olefin-based elastomer, or a polystyrene-based elastomer. According to such a configuration, the thermoplastic material used for the inner layer can have both strength and elasticity according to the intended use of the laminated resin tube. As the thermoplastic material used for the inner layer, resin materials of various grades can be selected. Therefore, a laminated resin tube having flexibility and bending performance suitable for various applications is obtained. In a case where a polyurethane resin is used for the inner layer, there are many choices of resin materials of grades having high flexibility and high elasticity. Further, the polyurethane resin is also excellent in processability during extrusion molding of the inner layer. Furthermore, by using the polyurethane resin, the productivity of the laminated resin tube increases, and the laminated resin tube can be produced at low cost. That is, mass production of the laminated resin tube can be achieved. The polyurethane-based elastomer has an extremely small Young's modulus and a large fracture strain. In a case where a polyurethane-based elastomer is used for the inner layer, the flexibility and bending performance of the laminated resin tube can be more remarkable. In this case, the laminated resin tube can be handled very easily. Therefore, the laminated resin tube that is easy to use is obtained. The laminated resin tube obtained in this manner can be applied to any application that does not require pressure resistance performance and the like.

### Supplementary Note 5

In the laminated resin tube according to any one of Supplementary Notes 1 to 4, the arithmetic average roughness of the surface of the outer layer may be 0.1 μm or less. According to such a configuration, a laminated resin tube having excellent chemical resistance and high transparency is obtained. The fluid conveyed in the laminated resin tube obtained in this manner can be visually recognized from the outside in an extremely satisfactory manner.

### Supplementary Note 6

In the laminated resin tube according to Supplementary Note 5, the inner layer may be colorless and transparent, or colored and transparent. According to such a configuration, various colors can be provided in the laminated resin tube. This makes it easy to distinguish the plurality of laminated resin tubes from each other. Further, the color of the inner layer is not lost by the outer surface of the laminated resin tube being exposed to dirt or abrasion. Therefore, the distinguishability among the plurality of laminated resin tubes is less likely to be reduced.

### Supplementary Note 7

In the laminated resin tube according to Supplementary Note 1, the inner layer, the intermediate layer, and the outer layer may be molded by co-extrusion. According to such a configuration, a laminated resin tube which is seamless and extremely long is obtained. Further, the laminated resin tube can be mass-produced at low cost.

### Supplementary Note 8

The molding method of the present disclosure is a method for molding the laminated resin tube according to Supplementary Note 1, the molding method including: causing the inner layer extruder (P4) to heat and melt the inner layer material (M4) of the inner layer, the inner layer material containing the thermoplastic resin or the thermoplastic elastomer; causing the intermediate layer extruder (P3) to heat and melt the intermediate layer material (M3) of the intermediate layer, the intermediate layer material containing the polyamide; causing the outer layer extruder (P2) to heat and melt the outer layer material (M2) of the outer layer, the outer layer material containing the fluoropolymer; and simultaneously performing extrusion of the inner layer material from the inner layer extruder into the die (D) by the inner layer extruder, extrusion of the intermediate layer material from the intermediate layer extruder into the die by the intermediate layer extruder, and extrusion of the outer layer material from the outer layer extruder into the die by the outer layer extruder, thereby performing co-extrusion molding of the inner layer, the intermediate layer, and the outer layer in the die. According to such a configuration, the laminated resin tube can be mass-produced at low cost.

Although the present disclosure has been described in detail, the present disclosure is not limited to the above-described individual embodiments. Various additions, replacements, modifications, partial deletions, and the like can be made to these embodiments without departing from the gist of the present disclosure or without departing from the gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A laminated resin tube comprising:
an inner layer containing a thermoplastic material which is a thermoplastic resin or a thermoplastic elastomer;
an intermediate layer provided on an outer periphery of the inner layer and containing a polyamide; and
an outer layer provided on an outer periphery of the intermediate layer and containing a fluoropolymer.

2. The laminated resin tube according to claim 1, wherein
a thickness of the outer layer is equal to or less than one-third of a sum of a thickness of the inner layer, a thickness of the intermediate layer, and the thickness of the outer layer.

3. The laminated resin tube according to claim 1, wherein
the fluoropolymer is an ethylene tetrafluoroethylene copolymer resin (ETFE) or a tetrafluoroethylene-perfluoroalkyl vinyl ether-chlorotrifluoroethylene copolymer resin.

4. The laminated resin tube according to claim 1, wherein
the thermoplastic material is any one of a polyurethane resin, a polyvinyl chloride resin, a polyurethane-based elastomer, a polyamide-based elastomer, an olefin-based elastomer, or a polystyrene-based elastomer.

5. The laminated resin tube according to claim 1, wherein
an arithmetic average roughness of a surface of the outer layer is 0.1 μm or less.

6. The laminated resin tube according to claim 5, wherein
the inner layer is colorless and transparent, or colored and transparent.

7. The laminated resin tube according to claim 1, wherein
the inner layer, the intermediate layer, and the outer layer are molded by co-extrusion.

8. A method for molding the laminated resin tube according to claim 1, the method comprising:
causing an inner layer extruder to heat and melt an inner layer material of the inner layer, the inner layer material containing the thermoplastic resin or the thermoplastic elastomer;
causing an intermediate layer extruder to heat and melt an intermediate layer material of the intermediate layer, the intermediate layer material containing the polyamide;
causing an outer layer extruder to heat and melt an outer layer material of the outer layer, the outer layer material containing the fluoropolymer; and
simultaneously performing extrusion of the inner layer material from the inner layer extruder into a die by the inner layer extruder, extrusion of the intermediate layer material from the intermediate layer extruder into the die by the intermediate layer extruder, and extrusion of the outer layer material from the outer layer extruder into the die by the outer layer extruder, thereby performing co-extrusion molding of the inner layer, the intermediate layer, and the outer layer in the die.
